(19) United States
(12) Patent Application Publication
(10) Pub. No.: US 2026/0292060 A1
(43) Pub. Date: Sep. 24, 2026

(54) SYSTEMS AND METHODS OF ENHANCED CALL IDENTIFICATION

(71) Applicant: Radicom Research, Inc., San Jose, CA (US)

(72) Inventor: MingChih HSIEH, Saratoga, CA (US)

(21) Appl. No.: 19/084,664

(22) Filed: Mar. 19, 2025

(51) Int. Cl. H04M 3/42

(52) U.S. Cl. CPC H04M 3/42042; H04M 3/42059; H04M 3/42221

(57) ABSTRACT

Systems and methods are provided for enhancing caller/call identification (ID) functionality by integrating initial and refined online search results and Artificial Intelligence (AI) features. These software systems enhance caller ID functionality to detect potential scams, spam, or otherwise unwanted calls, and integration is provided with traditional (e.g., landline) phone devices/systems and/or mobile smartphones or apps. AI-generated and preset rule processes are configured to provide statistical information, weighted determinations, suggestions, and ongoing training to improve future call handling.

### TECHNICAL FIELD

The present invention relates generally to systems, methods, and computer programs, and more particularly to computing systems configured to provide enhanced call identification and advanced information processing to deliver reliable and intelligent tools to a user to identity and avoid undesirable or unwanted calls.

### BACKGROUND OF THE INVENTION

Conventional caller identification (ID) systems are telecommunication services that provide the recipient of a phone call with information about the caller before the call is answered. This information typically includes the caller's phone number and, if available, the caller's name. Conventional systems work by transmitting the caller's information over the phone network to the recipient's phone, where it is displayed on a screen. Conventional caller ID systems are widely used in both landline and mobile phone networks to help users identify incoming calls.

However, these conventional caller ID systems include many weaknesses and disadvantages. For instance, conventional systems provide limited information, which is not sufficient to accurately identify the caller, especially if the number is unfamiliar. Further, traditional caller ID information can be easily spoofed, meaning that scammers and telemarketers can manipulate the displayed number to appear as if the call is coming from a trusted source. There is a lack of context, meaning the caller's location, purpose, and any previous or known interactions are not known or considered. In addition, known systems fail to offer real-time updates or additional verification options, making it difficult to identify and block spam or scam calls effectively.

The limitations of conventional caller ID systems highlight the need for enhanced caller identification solutions that can provide comprehensive, accurate, and real-time information and options to users.

### SUMMARY OF THE INVENTION

Various embodiments of the system of the present invention provide users with a reliable and intelligent tool to identity and avoid undesirable or unwanted calls by employing a multi-step process, including: caller identification (ID) reading and processing, integration of online searching, adaptive and refined searching techniques, Artificial Intelligence (AI) and machine learning, user interaction, caller voice and tone analysis, and scam/spam probability determinations. This, in turn, substantially improves accuracy, security, and the overall user experience. Unlike conventional caller ID systems that only show very limited information, the systems of the present invention provide comprehensive details, including AI-generated insights, directly on a display and/or via audio. Various embodiments are compatible with traditional, non-smartphones, while other embodiments function with or via an app with mobile devices, such as smartphones. Included AI and machine learning features and processing provide statistical information, weighted determinations, suggestions, and ongoing training to improve future call handling, and can implement voice recognition and synthesis for caller validation from menu selections and/or from AI to answer the call and/or to call back by or with different various schemes.

The present invention offers a robust, accurate, and user-friendly approach to caller identification, addressing many of the limitations of conventional caller ID systems. The above and other aspects and embodiments of the present invention are described below with reference to the accompanying drawings.

In various embodiments, a method of an advanced caller ID system comprises receiving an incoming call signal from a caller, extracting initial caller ID information from the incoming call signal, automatically conducting an electronic search via a web browser or a search application using at least the extracted initial caller ID information, extracting, from results of the electronic search, additional caller ID information related to the caller, displaying summary caller ID information to a user, including at least a portion of the initial caller ID information and/or at least a portion of the additional caller ID information, and determining whether to accept or reject the incoming call signal based at least on the summary Caller ID information and/or the additional caller ID information.

### BRIEF DESCRIPTION OF THE DRAWINGS

The accompanying drawings, which are incorporated herein and form part of the specification, illustrate various embodiments of the present disclosure and, together with the description, further explain the principles of the disclosure to enable a person skilled in the pertinent art to make and use the embodiments disclosed herein. In the drawings, like reference numbers indicate identical or functionally similar elements.

FIGS. 1-2 show exemplary block diagrams of the present invention included with traditional, non-smartphone, units and devices, in accordance with embodiments of the present invention.

FIG. 3A show an exemplary diagram of the present invention included with a smartphone device, and a telephone device in operative communication with a smartphone device, in accordance with embodiments of the present invention.

FIG. 3B shows an exemplary diagram of a smartphone device in operative communication with a Bluetooth paired device of the present invention, in accordance with embodiments of the present invention.

FIGS. 4-5 show an exemplary process diagram or flow chart of a software system for enhanced call identification and advanced information processing, in accordance with embodiments of the present invention.

FIG. 6 shows an exemplary process diagram or flow chart of a software system for enhanced call identification and advanced information processing, in accordance with embodiments of the present invention.

### DETAILED DESCRIPTION

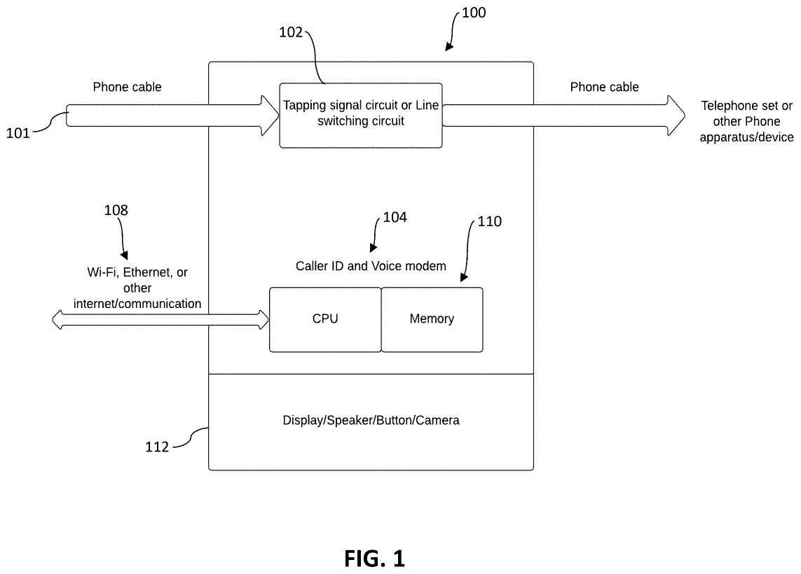

Referring generally to FIGS. 1-6, exemplary methods, systems, hardware and software modules, and computer software applications are configured to enhance current caller/call identification (ID) functionality by integrating online search results and Artificial Intelligence (AI) features. Embodiments of the present invention comprise a software system or application designed to enhance caller ID functionality to detect potential scams, spam, or otherwise unwanted calls. The present invention can be included or integrated with traditional (e.g., landline) phone devices/systems and/or mobile smartphones and apps.

Various embodiments of the present invention provide users with a reliable and intelligent tool to identity and avoid undesirable or unwanted calls by employing a multi-step process, including: caller ID reading, integration of online searching, adaptive and refined searching techniques, AI and machine learning, user interactions, caller voice and tone analysis, and scam/spam probability determinations. This, in turn, substantially improves security and the overall user experience.

The systems and methods of the present invention automatically, and in real time, bring up online information about the caller using a search engine or other online search techniques or search tools/applications, thereby providing details before, during, and/or after the call to help the receiver/user make informed decisions. Unlike conventional caller ID systems that only show very limited information, this system provides comprehensive details, including potential AI-generated insights, directly on a display or via audio. Various embodiments are compatible with traditional, non-smart phones, while other embodiments function via an app with mobile devices, such as smartphones. Included AI and machine learning features provide statistical information, suggestions, and ongoing training to improve future call handling, and can implement voice recognition and synthesis for caller validation. As such, the present invention uses real-time information and AI features to expose potential scams, junk calls, or even to identify long-lost friends, thereby providing various options for callback and verification for secure communication. The receiver/user can request a refined search when they cannot make a decision, or find it difficult to make a decision, based on the current search results, prompting the need for deeper investigation to gather additional relevant details.

Various devices or computing systems can be included and adapted to process and carry out the aspects, computations, and algorithmic processing of the systems of the present invention. Computing systems and devices of the present invention may include one or more microprocessors/processors or processing elements, which may include one or more microprocessors and/or one or more circuits, such as an application specific integrated circuit (ASIC), field-programmable gate arrays (FPGAs), etc. Further, the devices can include a network interface. The network interface is configured to enable communication with the network, other devices and systems, and servers, using a wired and/or wireless connection.

The devices or computing systems may include memory, such as non-transitive memory, which may include one or more non-volatile storage devices and/or one or more volatile storage devices (e.g., random access memory (RAM)). In instances where the devices include one or more microprocessors, computer readable program code may be stored in a computer readable medium or memory, such as, but not limited to storage media (e.g., a hard disk or solid-state drive), optical media, memory devices (e.g., random access memory, flash memory), etc. The computer program or software code can be stored on a tangible, or non-transitive, machine-readable medium or memory. In some embodiments, computer readable program code is configured such that when executed by a processor or processing element, the code causes the device to perform the steps described above and herein. In other embodiments, the device is configured to perform steps described herein without the need for code.

It will be recognized by one skilled in the art that these operations, algorithms, logic, method steps, routines, sub-routines, and modules may be implemented in software, in firmware, in special purpose digital logic, and any combination thereof without deviating from the spirit and scope of the present invention as recited within the claims attached hereto.

The computing devices may include an input device. The input device is configured to receive an input from either a user or a hardware or software component-as disclosed herein in connection with the various user interface or data inputs. Examples of an input device include a keyboard, mouse, buttons, microphone, touch screen and software enabling interaction with a touch screen, voice input, etc. The devices can also include an output device. Examples of output devices include monitors, televisions, fixed or mobile device screens, displays, tablet screens, speakers, remote screens, etc. The output device can be configured to display images, media files, text, or video, or play audio to a user through speaker output.

Server processing systems, for use or operatively connected with the systems of the present invention, can include one or more microprocessors/processors, and/or one or more circuits, such as an application specific integrated circuit (ASIC), field-programmable gate arrays (FPGAs), etc. A network interface can be configured to enable communication with the network, using a wired and/or wireless connection, including communication with devices or computing devices disclosed herein. Memory can include one or more non-volatile storage devices and/or one or more volatile storage devices (e.g., random access memory (RAM)). In instances where the server system includes one or more microprocessors, computer readable program code may be stored in a computer readable medium, such as, but not limited to storage media (e.g., a hard disk or solid-state drive), optical media, memory devices, etc.

The present invention can be embodied as software code residing on a user's computing device (e.g., desktop, tablet, fixed or mobile phone, and the like) and/or on one or more servers. The various data of the present invention can be included on and transferred to and from a storage area network (SAN), a data cloud, or any computing device for storing the file or files being uploaded, downloaded, or processed.

Aspects of the software code of the invention can take the form of a plugin or app and can interface with various protocols or software using Application Programming Interfaces (APIs) (e.g., social media platforms, websites, apps, etc.) or other means of interacting with computing software and systems.

### Traditional/Non-Smartphone Devices

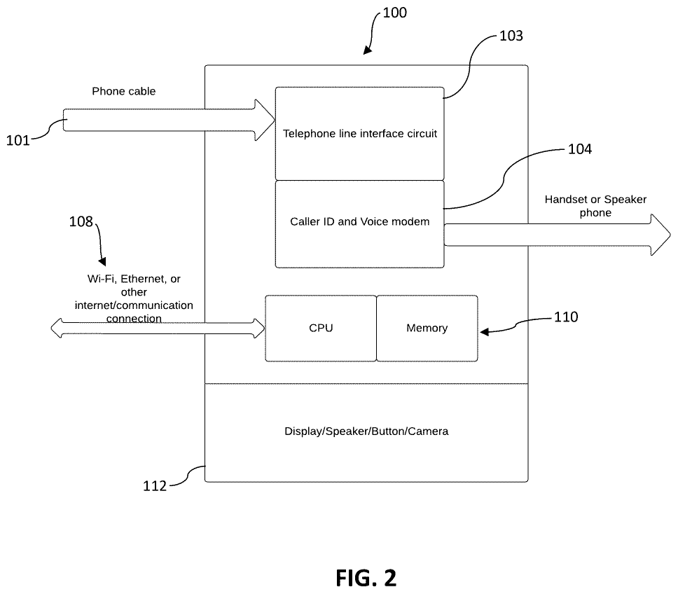

Referring to FIGS. 1-2, embodiments of the present invention are provided and integrated with “traditional,” non-smartphone devices (e.g., landline units or sets). For traditional telephone sets, the systems of the present invention can be implemented using an external device operatively connected to the phone line. This device will detect the incoming caller ID and name, use an internet connection (e.g., wireless Wi-Fi or cellular, wired, Ethernet, etc.) to retrieve information from a search engine or search tool/application/software, and provide additional AI features to the receiver or user.

As shown in FIG. 1, the traditional telephone device 100 handles telephone line signals from a phone line 101 through the following components and functions: a tapping signal and line switching circuit 102, a caller ID and voice modem 104, a telephone line interface circuit 106, a network communication element 108, a processing CPU and memory element 110, and a display or screen and camera element 112. The tapping signal and line switching circuit or hardware 102 is responsible for handling and routing the telephone line signals from the input phone cable or line 101. The hardware 102: (1) handles the telephone hardware interface to connect the device to the telephone line, thereby allowing it to tap into the incoming call signals, (2) facilitates signal routing to route the telephone line signals to the appropriate internal components, such as the caller ID and voice modem, and (3) ensures compatibility such that the signals from the telephone line are compatible with the device's internal processing systems, enabling accurate decoding and further processing of caller information. The device 100 can use or be embodied in an external device (separate, add-on, or retrofitted to a telephone unit) operatively connected to the phone line 101 with internet access, or an internal device integrated into the device 100 for operative connection to the phone line 101.

The tapping signal and line switching circuit or hardware 102 intercepts the incoming call signal to extract caller ID and other relevant information, routes the call signal to the appropriate components within the device 100, such as the modem and CPU, for further processing, and switches and manages the connection between the telephone line 101 and the device 100, ensuring that the call can be properly routed to the user or handled by the device's features (e.g., voice synthesis and AI processing for verification).

The caller ID and voice modem 104 decodes the caller ID information and passes or transfers the data to the CPU and memory system 110, as well as generates call and voice signals. As shown in FIG. 2, the device 100 can be integrated into a phone set and can include a telephone line interface circuit 103 to manage the hardware interface with the phone line 101, ensuring proper communication between the device 100 and the phone line 101.

The network communication element 108 is operatively connected to the CPU/memory system 110 to facilitate network communication (e.g., Internet, local network, etc.). The display or screen element (and/or camera element) 112 provides a visual output, and can facilitate input, for human interface and interaction with the device 100. These identified components work together to manage the telephone line signals, decode caller information, and facilitate the various features provided by the device 100.

The CPU and memory element 110 handles the features and processing tasks for the device 100, including execution of the enhanced call ID software system 300 further detailed herein. In various embodiments, the CPU and memory element 110 provides the following processing functionality: (1) data processing, such as caller ID and other data received from the modem 104, (2) internet searching, such as conducting online searches using one or more search engines of search tools/applications to retrieve detailed information about the caller, (3) AI integration to run algorithms to analyze and interpret the retrieved information to provide enhanced caller details and suggestions, (4) user interface management, managing the display, speaker, and input/selection buttons (virtual and/or physical) to present information to the user and accept user inputs, (5) voice recognition to process voice data for voice synthesis, recognition, verification purposes, (6) call handling, whereby the CPU manages the call flow, including decisions on whether to accept, reject, or further verify the call based on the processed information, (7) memory use and storage to store data, AI models, user preferences, and any other data or information to promote the functionality of the device 100, and (8) continuous learning functionality to retain and process user feedback and training data to improve AI accuracy and effectiveness over time. These functions enable the device 100 to provide a comprehensive and intelligent caller identification and verification system.

The display or screen element 112 visually shows detailed caller information retrieved from the search engine/application and processed by the AI. A speaker can provide audible information about the caller, including synthesized voice responses and alerts. One or more buttons (e.g., selection icons or inputs) can be provided to allow the user to interact with the device, such as accepting or rejecting calls, requesting further verification, or providing feedback to train the AI. Further, a camera can be included with this element 112 to provide screen/image inputs into the system for caller ID processing and AI use. The camera can also be used to receive image or video input from the user for system and AI processing and use.

### Mobile/Smartphone Device

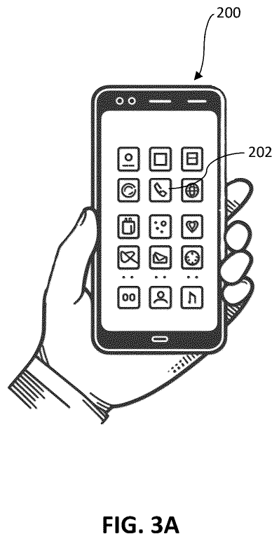

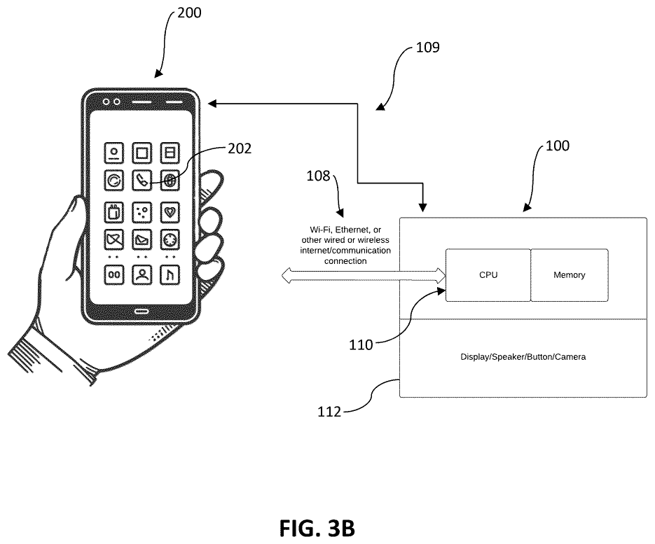

Referring to FIGS. 3A-3B, the present invention can be included with a mobile or smartphone device 200 via enhanced call ID software system 300 executed and running on the device 200, or in operative communication with the device 200. The device 200 can include a smartphone device running on various mobile operating systems, such as Apple iOS, Android OS, and others. The software system 300 can include the following operational benefits and features: (1) reading the caller ID (e.g., using the CallKit/Core Telephony Framework on iOS or the TelephonyManager class on Android OS), (2) integration with the native phone app 202 of the smartphone to obtain caller ID information (both iOS and Android OS impose restrictions on accessing data from the phone app, but the software works within these constraints to gather necessary information by any available and applicable way, including using ScreenCaptureKit Framework in iOS or ScreenCapture in Android, and/or from the external camera provided with the element 112, to capture the incoming calling information from the screen/display of element 112 and send to Optical Character Recognition (OCR) and/or to AI for reading and processing the caller ID information), (3) performing an initial search when a call is received, using a general search engine, e.g., Google®, Bing®, a search tool/application, and others-this can be accomplished by sending the information to a specified browser with a search string, using a WebView or otherwise applicable class for browsing, etc., (4) performing a refined or adaptive search If the initial search results are insufficient, wherein deeper and more complex searches can be employed using additional keywords and information found in previous searches, (5) using AI to analyze search results, identify patterns, and determine the likelihood of the call being a scam, which can include recognizing the caller's voice and tone for further validation, (6) facilitating user interaction by providing information and recommendations (e.g., via pop-ups or display and input options) to the user based on the search results and AI analysis, whereby the user can accept the call, drop the call, request further verification, etc., and (7) process the results of the call and user feedback to train the AI and improve the accuracy and effectiveness of the AI and the system for use with future calls.

Various screen capture frameworks or kits can be used with the present invention to facilitate high-performance screen and audio content capture capabilities from computing devices and/or smartphones, thereby providing fine-grained control over content selection and streaming. As such, the system can specify which content is to be used or processed, shared, or filtered out.

For the software system 300 of the present invention integrated or working with iOS, the software can be integrated with the phone app, e.g., through the use of the CallKit framework. In various embodiments, this integration includes CallKit to allow third-party apps to integrate with the native phone app to handle Voice over Internet Protocol (VoIP) calls and provide call blocking and identification services, e.g., via a Call Directory extension operating in the background. CallKit provides APIs for managing calls, including declining, starting, muting, ending, and holding calls. It also allows apps to report incoming and outgoing calls to the system of the present invention.

The software system 300 integrates with the native phone app, allowing VoIP calls to appear and behave like regular cellular calls, including displaying the call interface, handling call controls, and integrating with the call history. By using CallKit and the Call Directory extension, the software can effectively integrate with the iPhone's native phone app to provide enhanced call handling, identification, and blocking features, all while adhering to Apple's privacy and security standards.

For the software system 300 of the present invention configured to integrate or work within Android OS, the TelephonyManager Class framework can be used. The TelephonyManager Class is a system service in the Android operating system that provides information about the telephony services on the device 200. In certain embodiments, this integration can include access and reading the caller ID information when an incoming call is received, e.g., the phone number and the name of the caller, if available. As such, the software system 300 integrates with the native phone app of the device 200 to provide access to the call state (e.g., via “READ_PHONE_STATE”), to provide information for the software to determine when to activate the caller ID and scam/spam detection features, to facilitate online searches, pattern analysis, and application of AI algorithms to determine the likelihood that the call is spam or a scam. Further, “READ_CALL_LOG” allows the software system 300 running on (or in operative communication with) the Android operating system to read the call log of the user.

As shown in FIG. 3B, the device 200 can be in operative communication with the device 100 via Bluetooth pairing 109, wherein the device 100 of this embodiment can include all or a select portion of the functionality, features, and hardware described above and herein for the device 100 and the software system 300, including the network communication element 108 operatively connected to the CPU/memory system 110 and the device 200, as well as the display or screen element 112 (e.g., display, speaker, button, camera, etc.) to facilitate a visual output and/or human interface and interaction with (and input to) the device 100 and its corresponding native phone app 202. Both Bluetooth paired devices 100, 200 can process and communicate in sync mode and share caller ID information, even when one of the devices is not providing the caller ID information.

### Software System

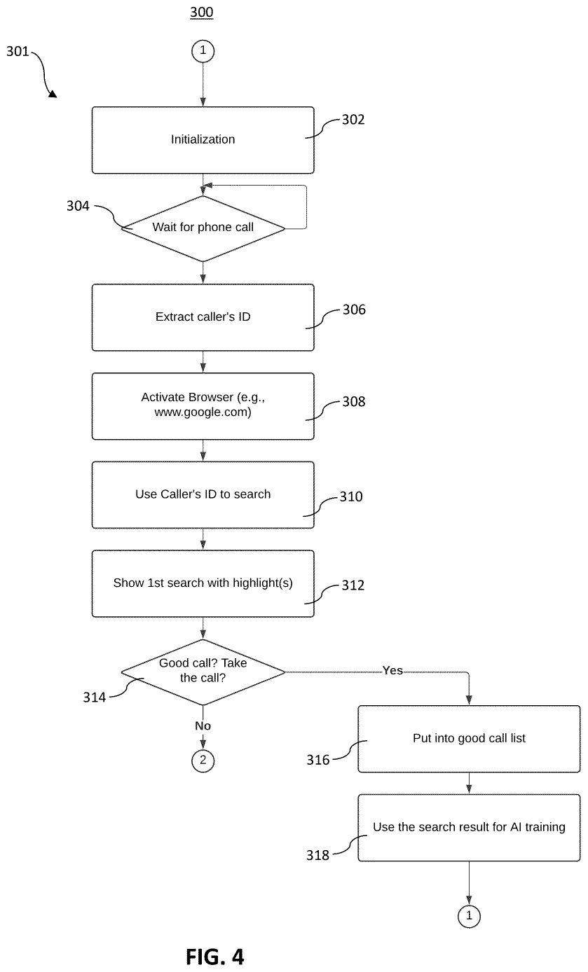

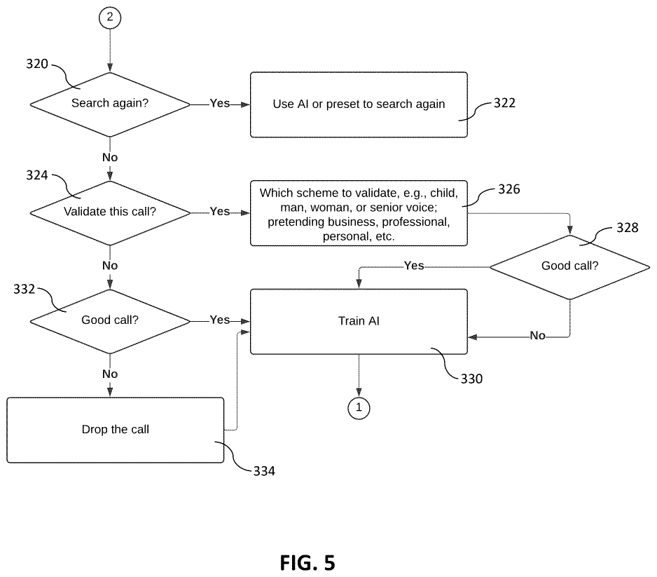

Referring to FIGS. 4-5, embodiments of the software 300 can include the system steps 301 of initialization of the software (step 302) and waiting for an incoming phone call (step 304). Once a call is received, the software extracts the caller's ID (step 306) and can then activates a web browser for searching (e.g., www.google.com, www.bing.com, etc.) or a search application/software (step 308). The details received from the extracted caller ID information can be automatically inputted into the search engine of the web browser (step 310), and the results of this initial search can be shown or displayed, with highlights, to the user (step 312), e.g., the receiver of the call. In certain embodiments, the user can then determine, based on the displayed caller ID details, whether to accept or reject the call (step 314). In various other embodiments, the software system 300 can automatically determine to reject the call based on information already known and stored for a particular caller.

If it is determined (automatically or manually by the user) that it is desirable to accept the call as a “good call,” the caller ID and information is stored in a good call list or database (step 316). As detailed further herein, this caller ID and information can be further used by the software system 300 to train and expand the system AI (step 318).

If it is determined (automatically or manually by the user) that the call is not a “good call,” the software system 300 can display an option to the user for further searching (step 320), as shown in FIG. 5. If there is a need/desire to perform further searching on the caller, the software system 300 can execute such a search using the system AI and/or search presets (step 322). If further searching is not desired, the software system 300 can display an option for call validation (step 324). If the user provides input indicating to proceed with validation of the call, from menu selections and/or from AI to answer and/or call back by or with various different schemes, the software system 300 processes various validation steps and criteria (step 326). Another determination can be made as to whether the call is a good call at this point (step 328) and the results are used to further train the AI (step 330). In situations where a call validation is not required or desired, a decision is made again to determine whether the call is a good call (step 332). As such, if a call is determined to be a good call, the system AI again receives the information for use in training (step 330). If the call is determined not to be a good call, the call is dropped or rejected (334), with the system AI also receiving this information for training (step 330).

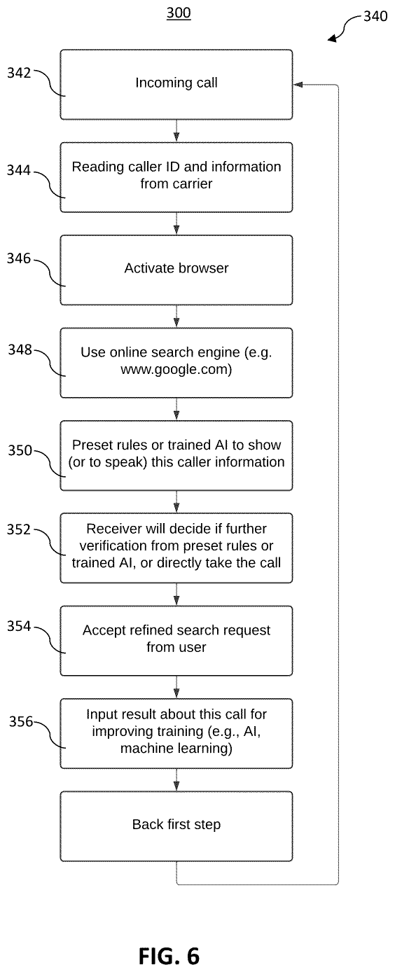

A flow chart of a software process 340, in accordance with embodiments of the present invention, is further shown in FIG. 6. An incoming call is received (step 342), the software system 300 reads the caller ID and information from the carrier (step 344), the web browser is activated (step 346), an online search engine is executed and used (step 348), preset rules and/or trained AI are executed to display and/or provide audible output (e.g., via a speaker output) of the caller ID and information (step 350), the user (e.g., receiver of the call) inputs a decision indicating whether further verification/searching is desired based on preset rules and/or trained AI, or whether to directly take the call at that time (step 352). If the user inputs a request for further verification/searching, the software system 300 accepts the refined search request (step 354) and inputs the details of the call/caller into the system for training (e.g., AI, machine learning, etc.) (step 356). The refined search steps detailed herein can then be performed, providing the user with additional information based on the refined search, AI information, rules, and the like. Once the determination is made for the call, by the user, the software system 300 can return to incoming call detection and processing (step 340).

The initial search conducted by the software system 300 can provide the user with the caller's full name associated with the phone number, additional information such as the caller's address, business affiliation, and other publicly available data, relevant online history or mentions of the caller (to help identify the nature of the call), potential warnings relating to scams or spam associated with the caller's number, and any other contextual information, such as details that can help the user make an informed decision about the call and caller. The search results can be presented to the user before, during, and after the call or the attempted call.

### Refined Searching

The further or refined search, in certain embodiments, can be employed under the following circumstances: (1) when the user cannot make a decision based on the initial information provided by the caller ID and the initial search results, (2) when the current search results do not provide enough information to determine the legitimacy of the call, (3) when the search results are complex or ambiguous, making it difficult for the user to ascertain whether the call is legitimate or a scam/spam, and (4) when there are indicators flagged by the software system 300 that the call might be a scam/spam, but the user needs more detailed information to confirm the suspicions. In these situations, the user can initiate a refined search to gather additional detailed and specific information to help make an informed decision.

The user initiates the refined search by selecting options on the display/screen, such as buttons or other input options provided by the app, to request further information. The software system 300 performs a deeper search using at least the content related to the phone number and/or name. This can include searching for any links or additional information that can be associated with the person or entity. The search can extend to finding email addresses, social media profiles, website information, or other relevant data linked to the phone number and/or the name. The software system 300 can conduct multiple rounds of searches, using new keywords or information found in previous searches to refine and narrow down the results. The user then reviews the refined search results and can decide whether to take or drop the call based on the additional information provided. This process continues until the user has enough information to make an informed decision or chooses to end the search. User feedback provides the software system 300 with information and data to improve AI training and accuracy.

### Preset Rules and AI

The preset rules and implementation of system AI for scam/spam detection includes using known information about scam/spam phone numbers and names to guide the AI's search and analysis. In various embodiments: (1) the system AI uses a database of confirmed scam/spam phone numbers and names collected from online sources and past calls/experiences, (2) these numbers and names are entered into search engines or search tools/applications to gather additional clues and information, (3) the system AI looks for patterns, such as frequent changes in ownership of a phone number, lack of registration, presence only on foreign websites, absence from any listings, etc., (4) the system AI analyzes the clues obtained from the initial search to refine its understanding and improve detection accuracy, (5) each parameter (e.g., frequency of phone number changes, registration status, etc.) is assigned a weight to help determine the likelihood of a scam/spam, and (6) the system AI performs multiple rounds of searches, using the results to fine-tune its parameters and improve its detection capabilities. The preset rules help the AI to systematically identify and flag potential scam/spam calls by leveraging known data and continuously refining its processing and detection methods.

The software system 300 can further provide an option for the user to respond to the caller with preset sentences designed to elicit more information from the caller. This can help in identifying whether the call is legitimate or is a scam or spam. Accordingly, the user can initiate further searches based on the information provided by the caller. For example, if the caller claims to be from a specific organization, the user can search, or initiate a search via the system, for more details about that organization and its association with the caller. The software system 300 can analyze the caller's pitch, tone, and accent to determine if it matches expected patterns for legitimate calls. This includes detecting fake voices or unusual accents that might indicate a scam or a spam call, which can include robotic voices or scripted responses. The system AI can simulate different voices (e.g., kids, young/old man/woman, professional, etc.) and accents to interact with the caller. By comparing the caller's responses to expected patterns, the AI can determine if the call is legitimate or not. For example, a genuine caller might respond differently to a question compared to a machine or scam/spam caller. This analysis helps in identifying the authenticity of the caller and these options provide the user with multiple ways to verify the legitimacy of a call and make an informed decision on whether to trust the caller or not.

The software AI determines the percentage of a scam/spam call by using a combination of preset rules, online searches, and machine learning techniques. Predefined or preset rules are derived from analyzing confirmed scam/spam phone numbers and names. Multiple online searches can start with basic information like the phone number and then the searches can be refined to use additional data, such as email addresses or social media links found during the various searches. For instance, if the system AI finds an email address linked to the phone number, it will use that email address to perform further searches to gather more context and verify the legitimacy of the caller via the caller's profile(s) and online information. If inconsistencies in the caller's information are detected, such as mismatched names and phone numbers, or the absence of any online presence, this can be indicative of a scam/spam call and, thereby, can be flagged accordingly by the software system 300.

The system AI uses machine learning algorithms to weigh various parameters and indicators. The AI continuously learns from new data and user feedback to improve its accuracy. For example, if a user marks a call as a scam/spam call, the AI will use that information to adjust its parameters and improve future predictions. Based on the collected data and analysis, the system AI calculates a probability score indicating the likelihood of the call being a scam/spam call. This score is presented as a percentage or likelihood to the user. The system AI incorporates user feedback to refine its predictions and suggestions. If a user confirms a call as legitimate or illegitimate, this information is used to update the system AI's model and improve its accuracy over time. As a result, the system AI can provide a reliable estimate of the likelihood that a call is a scam/spam call, helping users to make informed decisions about whether to answer or ignore a call.

The capabilities of the system software AI make the caller identification process intelligent, personalized, and secure, significantly enhancing the user's ability to handle incoming calls effectively. The software system 300 allows users to train the AI, improving its accuracy and effectiveness over time by learning from user feedback, the results determined and processed by the AI system, and refining its responses. The system AI can efficiently identify and flag potential illegitimate calls, improving over time with more data and user interactions.

Any of the above-detailed embodiments of FIGS. 1-3B can employ all or a portion of the described system processing, software, AI processing, searching, method steps, and aspects detailed herein.

With this and other concepts, systems, and methods of the present invention, a method of an advanced caller ID system comprises receiving an incoming call signal from a caller, extracting initial caller ID information from the incoming call signal, automatically conducting an electronic search via a web browser or a search application/software using at least the extracted initial caller ID information, extracting, from results of the electronic search, additional caller ID information related to the caller, displaying summary caller ID information to a user, including at least a portion of the initial caller ID information and/or at least a portion of the additional caller ID information, and determining whether to accept or reject the incoming call signal based at least on the summary Caller ID information and/or the additional caller ID information.

In various embodiments, the method further comprises processing preset or pre-trained parameters to augment the displayed summary caller ID information.

In various embodiments, the user further selects criteria for an additional electronic search to retrieve additional information related to the caller.

In various embodiments, the method further comprises initiating an AI processing component to process at least the summary caller ID information and/or the additional caller ID information to assist the user in making the determination whether to accept or reject the incoming call signal.

In various embodiments, the AI processing component uses pre-trained or pre-set rules to assist in identifying the caller.

In various embodiments, the AI processing component analyzes one or more of: a voice tone of the caller, a subject matter, and a context.

In various embodiments, the AI processing component sends human voice signals to communicate with the caller, wherein the human voice signals are consistent with a particular age, gender, and/or profession.

In various embodiments, data processed by the AI processing component is stored for training purposes to improve future electronic searches.

In various embodiments, at least conducting the electronic search, extracting the additional caller ID information, and displaying the summary caller ID information are performed via a wired telephone device or a smartphone device.

In various embodiments, the method further comprises communicating with a smartphone device via Bluetooth pairing.

In various embodiments, extracting at least a portion of the initial caller ID information is performed using a screen capture framework of an operating system of the smartphone device and/or via input from an external camera.

In one or more embodiments from the perspective of an advance caller ID system, a program code is stored in memory and the memory is in operative communication with a processor (or CPU or processing element), wherein the processor can execute the program code to: (i) receive an incoming call signal from a caller; (ii) extract initial caller ID information from the incoming call signal; (iii) automatically conduct an electronic search via a web browser or a search application using at least the extracted initial caller ID information; (iv) extract, from results of the electronic search, additional caller ID information related to the caller; (v) display summary caller ID information to a user, including at least a portion of the initial caller ID information and/or at least a portion of the additional caller ID information; and (vi) determine whether to accept or reject the incoming call signal based at least on the summary Caller ID information and/or the additional caller ID information. Additionally or alternatively, the processor can execute the program code to perform all of the described actions, steps, and methods described above, below, or otherwise herein.

While various embodiments have been described above, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

While the methods, steps, and processing described above and illustrated in the drawings are shown as a sequence of steps, this was done solely for the sake of illustration. Accordingly, it is contemplated that some steps may be added, some steps may be omitted, the order of steps may be re-arranged, and some steps may be performed in parallel.

It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of 35 U.S.C. § 112(f) are not to be invoked unless the specific terms “means for” or “step for” are recited in a claim.

What is claimed is:

1. A method of a caller identification (ID) system, comprising:
receiving an incoming call signal from a caller;
extracting initial caller ID information from the incoming call signal;
automatically conducting an electronic search via a web browser or a search application using at least the extracted initial caller ID information;
extracting, from results of the electronic search, additional caller ID information related to the caller;
displaying summary caller ID information to a user, including at least a portion of the initial caller ID information and/or at least a portion of the additional caller ID information; and
determining whether to accept or reject the incoming call signal based at least on the summary Caller ID information and/or the additional caller ID information.

2. The method of claim 1, further comprising processing preset or pre-trained parameters to augment the displayed summary caller ID information.

3. The method of claim 1, wherein the user further selects criteria for an additional electronic search to retrieve additional information related to the caller.

4. The method of claim 1, further comprising initiating an Artificial Intelligence (AI) processing component to process at least the summary caller ID information and/or the additional caller ID information to assist the user in making the determination whether to accept or reject the incoming call signal.

5. The method of claim 4, wherein the AI processing component uses pre-trained or pre-set rules to assist in identifying the caller.

6. The method of claim 4, wherein the AI processing component analyzes one or more of: a voice tone of the caller, a subject matter, and a context.

7. The method of claim 4, wherein the AI processing component sends human voice signals to communicate with the caller, wherein the human voice signals are consistent with a particular age, gender, and/or profession.

8. The method of claim 4, wherein data processed by the AI processing component is stored for training purposes to improve future electronic searches.

9. The method of claim 1, wherein at least conducting the electronic search, extracting the additional caller ID information, and displaying the summary caller ID information are performed via a wired telephone device or a smartphone device.

10. The method of claim 1, further comprising communicating with a smartphone device via Bluetooth pairing.

11. The method of claim 10, wherein extracting at least a portion of the initial caller ID information is performed using a screen capture framework of an operating system of the smartphone device and/or via input from an external camera.

12. A caller identification (ID) system, comprising:
a memory; and
a processor operatively coupled with the memory, wherein the processor is configured to execute a program code to:
receive an incoming call signal from a caller;
extract initial caller ID information from the incoming call signal;
automatically conduct an electronic search via a web browser or a search application using at least the extracted initial caller ID information;
extract, from results of the electronic search, additional caller ID information related to the caller;
display summary caller ID information to a user, including at least a portion of the initial caller ID information and/or at least a portion of the additional caller ID information; and
determine whether to accept or reject the incoming call signal based at least on the summary Caller ID information and/or the additional caller ID information.

13. The system of claim 12, wherein the processor is further configured to execute the program code to process preset or pre-trained parameters to augment the displayed summary caller ID information.

14. The system of claim 12, wherein the user further selects criteria for an additional electronic search to retrieve additional information related to the caller.

15. The system of claim 12, wherein the processor is further configured to execute the program code to: initiate an Artificial Intelligence (AI) processing component to process at least the summary caller ID information and/or the additional caller ID information to assist the user in making the determination whether to accept or reject the incoming call signal.

16. The system of claim 15, wherein the AI processing component uses pre-trained or pre-set rules to assist in identifying the caller.

17. The system of claim 15, wherein the AI processing component analyzes one or more of: a voice tone of the caller, a subject matter, and a context.

18. The system of claim 15, wherein the AI processing component sends human voice signals to communicate with the caller, wherein the human voice signals are consistent with a particular age, gender, and/or profession.

19. The system of claim 15, wherein data processed by the AI processing component is stored for training purposes to improve future electronic searches.

20. The system of claim 12, wherein at least conducting the electronic search, extracting the additional caller ID information, and displaying the summary caller ID information are performed via a wired telephone device or a smartphone device.

21. The system of claim 12, wherein the processor is further configured to execute the program code to communicate with a smartphone device via Bluetooth pairing.

22. The system of claim 21, wherein extracting at least a portion of the initial caller ID information is performed using a screen capture framework of an operating system of the smartphone device and/or via input from an external camera.
